(19) United States
(12) Patent Application Publication
(10) Pub. No.: US 2015/0183368 A1
(43) Pub. Date: Jul. 2, 2015

(54) NOVELTY LICENSE PLATE HOLDER

(71) Applicant: Mark R. Wilkerson, Raleigh, NC (US)

(72) Inventor: Mark R. Wilkerson, Raleigh, NC (US)

(21) Appl. No.: 14/584,467

(22) Filed: Dec. 29, 2014

Related U.S. Application Data
(60) Provisional application No. 61/922,380, filed on Dec. 31, 2013.

(51) Int. Cl. B60Q 1/56; B60Q 1/26; F21V 33/00

(52) U.S. Cl. CPC B60Q 1/56; F21V 33/008; B60Q 1/2696; F21Y 2101/02

(57) ABSTRACT

The present invention provides a brightly illuminated, at least partially translucent, novelty license plate and holder for attachment on to a motor vehicle, wherein the plate is quickly interchangeable to suit an individual's aesthetic needs. Moreover, the device is adapted to enhance visibility at night, provides a means of advertising for companies and is wired into the headlight system of a motor vehicle.

This application claims priority of U.S. provisional application No. 61/922,380 filed on Dec. 31, 2013 and is included herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a device for a car. In particular, it relates to a device for holding a novelty license plate.

2. Description of Related Art

Novelty license plates are difficult to see on the front or back of vehicles at night. Additionally, companies are always seeking inexpensive yet effective ways to advertise.

Devices are known in the prior art that relate to illuminated license plate displays, but little or nothing is known for novelty license plates which are frequently changed. Some devices provide illuminated license plates that include a translucent plate, a light source, and a housing to hold the license plate. These devices and plates are attached to the exterior of a vehicle with screws and activated in periods of darkness to illuminate the license plate. Other devices provide illuminators that comprise a rectangular frame with a plurality of lights that are adapted for illuminating the plate from the front. These prior art devices, however, fail to provide easily removable illuminated license plates.

### BRIEF SUMMARY OF THE INVENTION

The present invention provides a car novelty license plate holder that allows a semi-translucent license plate to be easily seen and easily changed out. It is also lit from behind and turned on by being connected to the car's headlight switch.

Accordingly, the present invention is a system for displaying an at least partially translucent and easily replaced novelty license plate on a motor vehicle comprising a frame housing for holding the novelty license plate comprising:
a) a slot for inserting and removing the novelty license plate in front of a back section of the frame housing;
b) one or more lights positioned on the back section of the frame housing for backlighting a novelty license plate;
c) a device for connecting the lights to the vehicle to power the lights.

### BRIEF DESCRIPTION OF THE DRAWINGS

FIG. 1 displays a view of the present invention, the novelty license plate in mounting bracket on the front of a vehicle.

FIG. 2 displays a frontal view of the novelty license plate sliding into the holding bracket.

FIG. 3 displays a perspective view of the novelty plate sliding into the mounting bracket.

### DETAILED DESCRIPTION OF THE INVENTION

This detailed description defines the meaning of the terms used herein and specifically describes embodiments in order for those skilled in the art to practice the invention.

The terms “about” and “essentially” mean±10 percent.

The term “comprising” is not intended to limit inventions to only claiming the present invention with such comprising language. Any invention using the term comprising could be separated into one or more claims using “consisting” or “consisting of” claim language and is so intended.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

References throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention and are not to be considered as limitations thereto.

The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “displaying” refers to attaching a frame housing to the standard license plate holder on the front or back of a motor vehicle, such as a car or truck. In one embodiment, it refers to the license plate attachment on the front of a motor vehicle where there is only a back license plate and the front attachment is utilized for novelty license plates. As used herein, the term “license plate” refers to a sign affixed to a vehicle displaying a series of letters or numbers indicating that the vehicle has been registered with the state.

As used herein, the term “novelty license plate” refers to a plate that is designed to be mounted on the designated place for license plates, but is not for the purpose of indicating state license registration. It is typically used for providing information for such things as animals, businesses, dealerships, events, military affiliations, personalized designs, political affiliations, religious affiliations, sports teams, hobbies, flags, organizations, and the like. The novelty plate is at least partially translucent such that a light behind it will allow some light to shine through the plate. In one embodiment, the plate is entirely translucent.

As used herein, the term “frame housing” refers to a box type frame for holding a license plate of any kind by the edges, as shown in the figures. In one embodiment, it is rectangular to mimic the general shape of license plates and novelty license plates. The frame has a slot for sliding the novelty plate into the frame and positioning it in the front section of the frame. The slot can be on top and the width of a plate, or on the side and the height of the plate. The plate, then, either slides in top to bottom, or side to center, so that the public can view the plate (except for the small amount of edges held by the frame itself). The novelty plate can be held in place by brackets or other means known in the art, including brackets with a top slot frame housing where it sits on the ledge. Since the novelty plate is not screwed in place like standard novelty and regular plates which require a screwdriver, the novelty plate can be removed and replaced in a matter of seconds with no tools, i.e. a tool-less installation.

As used herein, the term “back section” refers to the area behind the novelty plate when inserted and the back inside of the frame, again as shown in the drawings. One or more lights (such as LEDs) are positioned behind the novelty plate so that when they are lit they will light up and shine through the translucent portions of the novelty license plate. In one embodiment, the lights are mounted on the back inside surface of the frame, as shown in the drawings.

As used herein, the term “a device for connecting the lights to the vehicle power” refers to utilizing the motor vehicle's battery or other electrical generating system that powers the vehicle lights to provide power to the device's lights. In one embodiment, the connection is wiring which connects the device to the switch that turns on the headlights of the vehicle, so that when the vehicle's headlights are engaged, the novelty license plate system lights are also engaged (and likewise turned off). Any other connection to electrical power is also contemplated.

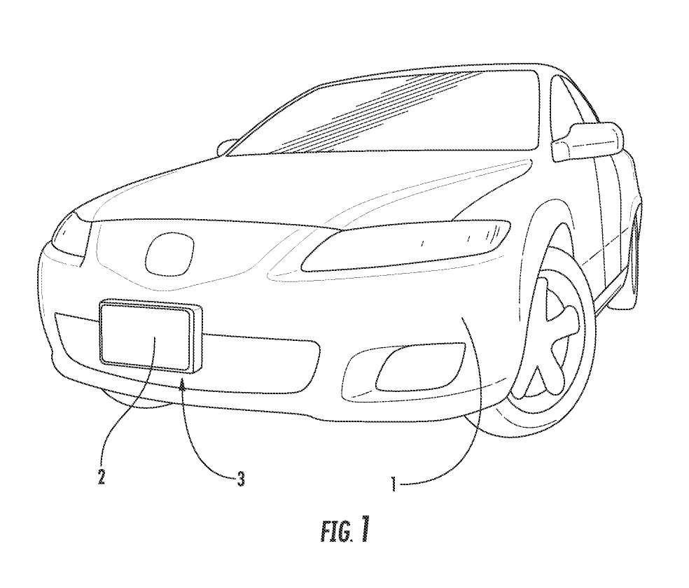

Referring now to FIG. 1, there is displayed a perspective view of the system frame and novelty license plate of the present invention on the front of a vehicle 1. The present invention provides an interchangeable novelty license plate with a backlight illumination frame housing. The device comprises a rectangular housing, made from plastic or other suitable material, which attaches to the front of an automobile. In use, an individual can insert the desired vanity plate into the housing, thereafter the plate is illuminated by a plurality of lights when the automobile's lights are active. In this view, novelty license plate 2 is positioned in the frame housing 3 and mounted on car 1. Plate 2 is illuminated from lights behind the plate 2.

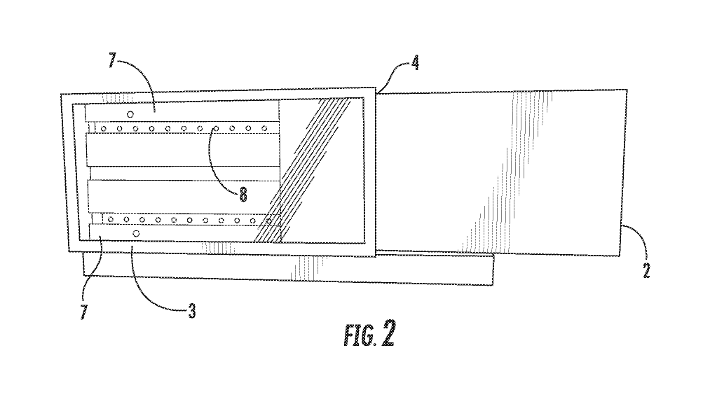

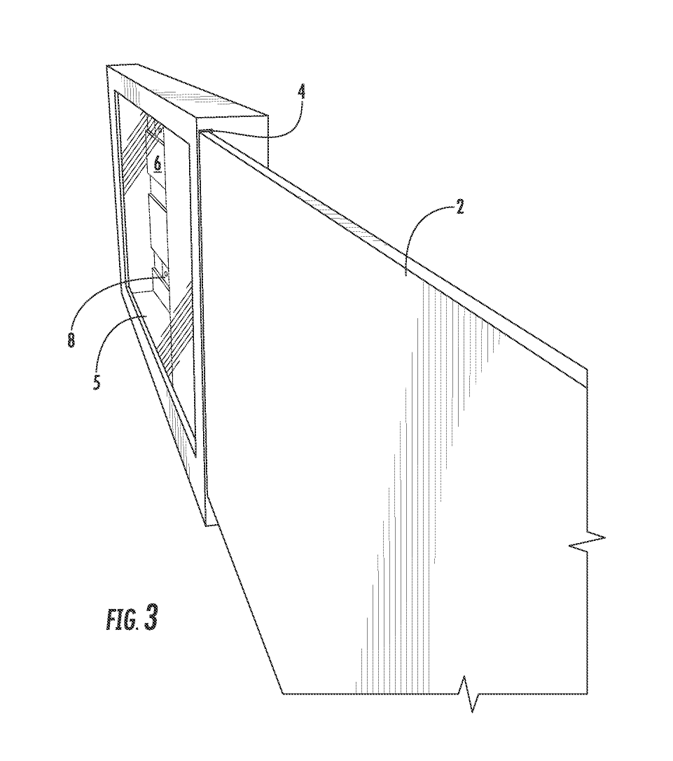

Referring now to FIGS. 2 and 3, there are displayed views of the novelty license plate sliding into the frame housing 3 by using a slot 4 and onto the front section 5 of frame 3. The novelty plates are slidable onto a rectangular housing. The housing includes a back section 6 and a pair of upper and lower brackets 7 that are adapted to support a single novelty plate. The brackets 7 facilitate the sliding of the plate over a plurality of lights 8 located on the back section of the housing 3, thereby securing the plate therein.

In use, an individual may select one of a variety of novelty plates that are sized for reception within the upper and lower brackets of the housing. The housing can further include a wired connection to the vehicle's headlight system, wherein when a driver activates the headlights, the plurality of lights illuminate, thereby illuminating the novelty plate. The novelty plate can be offered in a wide assortment of colors and designs to accommodate the needs of both individuals and companies. In this way, the present invention provides an illuminated novelty plate that is adapted for attachment onto an automobile.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art, still fall within the scope of the invention as claimed by the applicant.

What is claimed is:

1. A system for displaying and easily replacing an at least partially translucent novelty license plate on a motor vehicle, comprising a frame housing holding the novelty license plate comprising;
a) a slot for inserting and removing the novelty license plate in front of a back section of the frame housing;
b) one or more lights positioned on the frame housing for backlighting a novelty license plate; and
c) a device for connecting the lights to the vehicle to power the lights.

2. The system according to claim 1 wherein the lights are connected to the vehicle's lights in a manner that the system lights are activated when the vehicle lights are activated.

3. The system according to claim 1 wherein the slot is on the side of the frame housing.

4. The system according to claim 1 wherein the lights are LEDs.

5. The system according to claim 1 wherein the box frame housing is attached to a vehicle where a license plate would be attached.

6. The system according to claim 1 wherein an at least partially translucent novelty plate is inserted into the frame housing.

7. The system according to claim 6 wherein the system is mounted on a motor vehicle.

8. The system according to claim 6 wherein one or more brackets hold the novelty license plate in place.
